(19) United States
(12) Patent Application Publication
(10) Pub. No.: US 2007/0076617 A1
(43) Pub. Date: Apr. 5, 2007

(54) Sensor network and method for maintaining a task using a query cache

(75) Inventors: Hun Lim, Seoul (KR); Su-myeon Kim, Suwon-si (KR); Won-keun Kong, Suwon-si (KR); Kyle Kim, Suwon-si (KR); Kyung-soo Lim, Seoul (KR); Kyu-ho Han, Seoul (KR); Sun-shin An, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/515,780

(22) Filed: Sep. 6, 2006

(30) Foreign Application Priority Data
Sep. 30, 2005 (KR) 2005-92363

(51) Int. Cl. H04L 12/26; H04L 12/56

(52) U.S. Cl. 370/241; 370/400

(57) ABSTRACT

A sensor network and method for task maintenance query using a query cache are provided. When a query generated by a user is transmitted through a relay node to a sensor node, the relay node can accurately transmit the query to a newly installed sensor node or a sensor node moving from another area to a specific area using a query cache. Thus, the reliability of the transmission of the query can be improved, and thus a task of the query can be maintained.

### CROSS-REFERENCE TO RELATED APPLICATIONS

This application claims the benefit under 35 U.S.C. §119(a) of Korean Patent Application No. 2005-92363 filed on Sep. 30, 2005 in the Korean Intellectual Property Office, the entire disclosure of which is hereby incorporated by reference.

### BACKGROUND OF THE INVENTION

1. Field of the Invention

The present invention relates to a task maintenance method using a query cache in a wireless sensor network. More particularly, the present invention relates to a sensor network and method for task maintenance using a query cache by which a query generated by a request: of a user is accurately transmitted to a newly installed sensor node or a moving sensor node using the query cache. Sensor network and method according to the present invention aim to improve the reliability of the transmission of the query and maintain a task of the query.

2. Description of the Related Art

FIG. 1 is a schematic view showing a configuration of a conventional wireless sensor network. Referring to FIG. 1, the conventional wireless sensor network includes relay nodes 102 through 107, an access node 110, and first sensor nodes 120, 122, 124, and 126.

The first sensor nodes 120, 122, 124, and 126 transmit sensing data sensed by a plurality of sensors S1, S2, . . . , and Sn to the relay nodes 105 and 106, and the relay nodes 105 and 106 transmit the sensing data collected from the first sensor nodes 120, 122, 124, and 126 to the access node 110. The relay nodes 102 through 107 provide a data transmission path from the first sensor nodes 120, 122, 124, and 126 to the access node 110. Also, the access node 110 is connected to a backbone network such as the Internet or a local area network (LAN) and transmits the sensing data received from the relay nodes 102 through 107 to a user terminal such as a computer or the like connected to the backbone network.

A query generated by the user terminal must be accurately transmitted via the access node 110 and the relay nodes 102 through 107 to the first sensor nodes 120, 122, 124, and 126 in the wireless sensor network as structured above so as to accurately respond to the query. The wireless sensor network collects the desired sensor reading from the first sensor nodes 120, 122, 124, and 126 and then transmits the sensor reading to the user terminal.

Here, a query message generated by the user terminal is broadcast to the entire wireless sensor network. Thus, in a case of a broadcasting method, an unspecific plurality of relay nodes receives the query message. Thus, a query cannot be accurately transmitted.

Also, sensor nodes may be low priced and only support low power wireless communications driven with a battery. Thus, a query message may not be accurately transmitted to the first sensor nodes with one-time broadcasting.

Furthermore, a wireless sensor network exists for a long time, for example, for 2 years or more. However, the first, original, sensor nodes may have faults or be replaced with improved new, second sensor nodes within a shorter time than the time for which the wireless sensor network exists. Thus, one-time broadcasting cannot secure a transmission of a query to the second sensor nodes.

In addition, the sensor nodes are highly likely to move. Thus, the one-time broadcasting cannot secure a transmission of the query to the sensor nodes.

Accordingly, there is a need for an improved sensor network and method for transmitting a query.

### SUMMARY OF THE INVENTION

Exemplary embodiments of the present invention address at least the above problems and/or disadvantages and provide at least the advantages described below. Accordingly, an aspect of the present invention is to provide a sensor network and method for task maintenance using a query cache by which a query generated by a request of a user is accurately transmitted to a newly installed sensor node or a moving sensor node using the query cache so as to improve the reliability of the transmission of the query and maintain a task of the query.

According to an exemplary aspect of the present invention, there is provided a sensor network and method for task maintenance using a query cache, including receiving a query requested by a user from an access node, storing the query and generating a query cache, and transmitting the query to a corresponding sensor node using the query cache.

If the query comprises a position attribute similar to that of the sensor node, the query may be stored and the query cache may be generated.

The query may comprise attributes including at least one of position information as to a place to be sensed, information as to a desired sensing type, information as to a time required for sensing and transmitting, information as to a time required for transmitting a first response to the query, and information as to a time required for transmitting a last response to the query.

If the corresponding sensor node has position information similar or identical to the position attribute of the query, the query may be transmitted to the corresponding sensor node.

The query may be transmitted to a sensor node that is newly installed in the wireless sensor network, using the query cache. The task maintenance method includes adding the newly installed sensor node to a task table entry and transmitting information as to the newly installed sensor node to the access node if the newly installed sensor node exists.

The storing of the query to generate the query cache may include searching sensor nodes to detect a sensor node that does not operate any more or does not exist. The task maintenance method may further include deleting the sensor node that does not operate any more or does not exist from a task table entry and transmitting information as to the deletion to the access node.

The query may also be transmitted to a sensor mode that has moved from another area to a specific area, using the query cache.

### BRIEF DESCRIPTION OF THE DRAWINGS

The above and other objects, features and advantages of certain embodiments of the present invention will be more apparent from the following description taken in conjunction with the accompanying drawings, in which:

FIG. 1 is a schematic view illustrating a configuration of a conventional wireless sensor network;

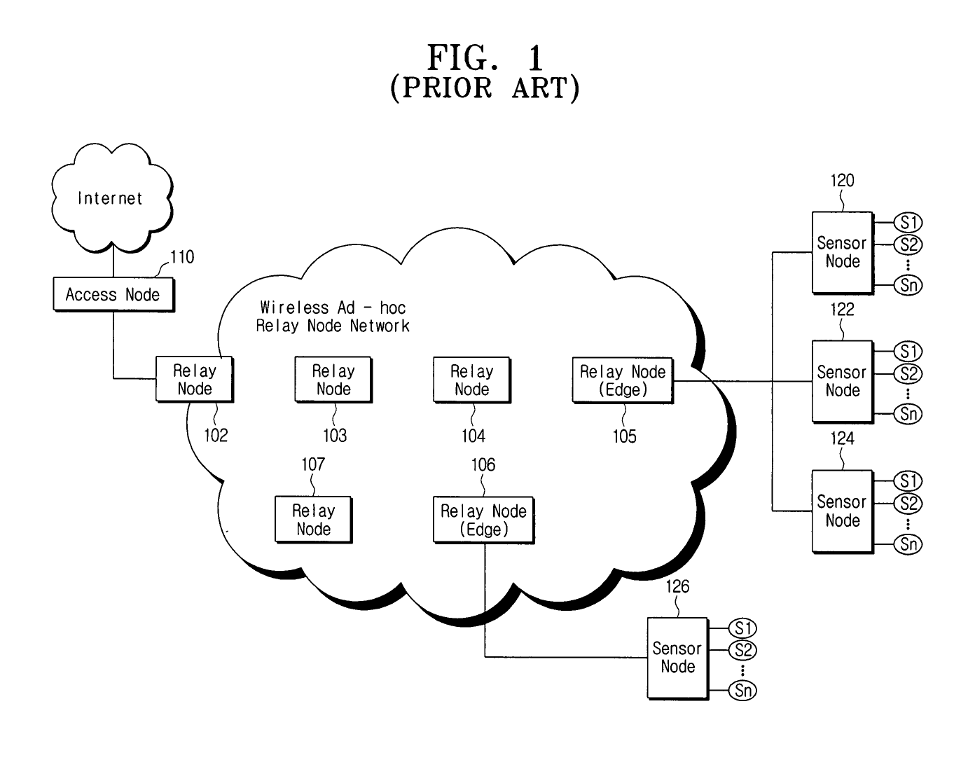

FIG. 2 is a view illustrating a configuration of a wireless sensor network adopting a task maintenance method using a query cache according to an exemplary embodiment of the present invention;

FIG. 3 is a view illustrating a task maintenance method using a query cache when a new sensor node is added in an interested area according to an exemplary embodiment of the present invention;

FIG. 4 is a flowchart of a task maintenance method using a query cache in a wireless sensor network according to an exemplary embodiment of the present invention;

FIG. 5 is a flowchart of a task maintenance method using a query cache in a wireless sensor network when a new sensor node is installed according to an exemplary embodiment of the present invention; and

FIG. 6 is a flowchart of a task maintenance method using a query cache in a wireless sensor network when a sensor node moves.

Throughout the drawings, the same drawing reference numerals will be understood to refer to the same elements, features, and structures.

### DETAILED DESCRIPTION OF EXEMPLARY EMBODIMENTS

Certain exemplary embodiments of the present invention will be described in greater detail with reference to the accompanying drawings.

The matters defined in the description such as a detailed construction and elements are nothing but the ones provided to assist in a comprehensive understanding of the invention. Accordingly, those of ordinary skill in the art will recognize that various changes and modifications of the embodiments described herein can be made without departing from the scope and spirit of the invention. Also, well-known functions or constructions are omitted for clarity and conciseness.

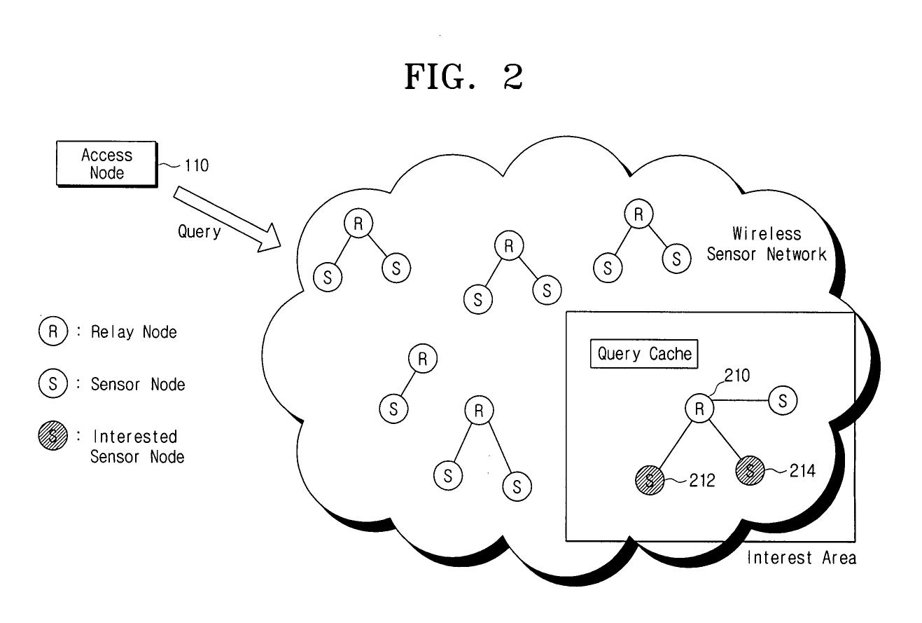

FIG. 2 illustrates a configuration of a wireless sensor network adopting a task maintenance method using a query cache according to an exemplary embodiment of the present invention.

Referring to FIG. 2, the wireless sensor network includes an access node 110, a relay node 210, and sensor nodes 212 and 214.

The access node 110 receives a query through a backbone network, for example, the Internet, from a user terminal and transmits the query to a relay node 210.

The relay node 210 receives the query from the access node 110. If the query comprises a position attribute similar to a position attribute of the relay node the relay node stores the corresponding query, generates a query cache, and forwards the corresponding query to the sensor nodes 212 and 214 corresponding to the position attribute of the query.

The sensor nodes 212 and 214 are positioned in an interest area. If the sensor nodes 212 and 214 receive the query from the relay node 210, the sensor nodes perform a sensing operation with respect to the query and then transmit sensing data in response to the query through the relay node 210 to the access node 110.

In other words, as shown in FIG. 2, in a wireless sensor network including a plurality of relay nodes R to each of which one or more sensor nodes S are connected, the relay node 210, positioned in the area of interest and responsible for responding to the query, receives the query and generates a query cache. The relay node then reads the corresponding query from the query cache and transmits the corresponding query to the sensor nodes 212 and 214 as query transmission objects in the interest area.

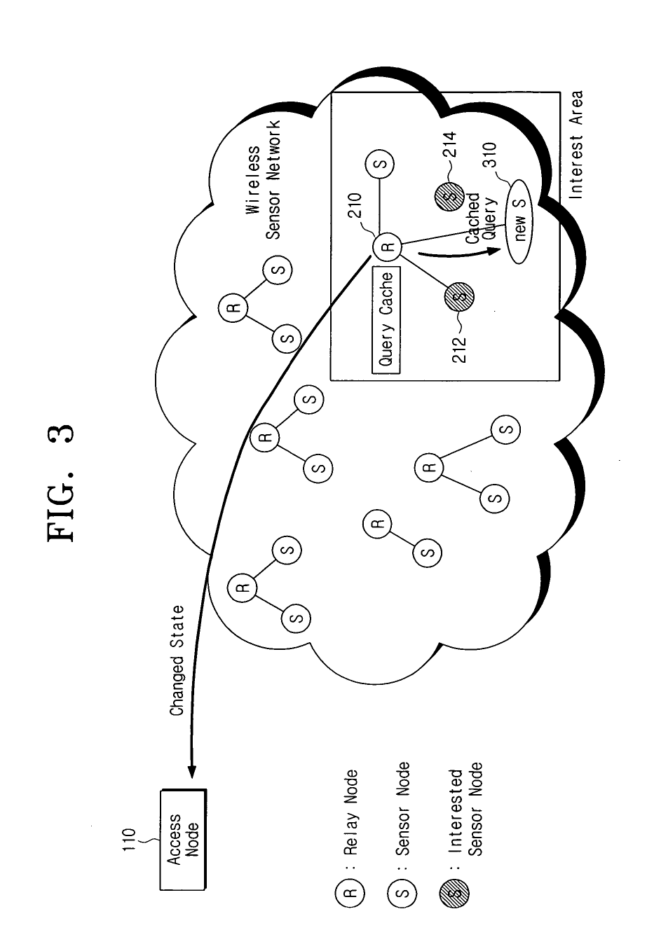

FIG. 3 is a view illustrating a task maintenance method using a query cache when a new sensor node is added in an interest area according to an exemplary embodiment of the present invention.

As shown in FIG. 3, if a relay node 210 positioned in an interest area and responsible for responding to a query receives the query from an access node 110, the relay node 210 generates a query cache, transmits the corresponding query to applicable sensor nodes as query transmission objects using the query cache, and transmits a cached query to a second sensor node 310 that is newly installed.

Thus, the second sensor node 310 newly installed in the interest area can also receive the corresponding query that has been requested by a user and transmit response data to the query through the relay node 210 and the access node 110 to a user terminal.

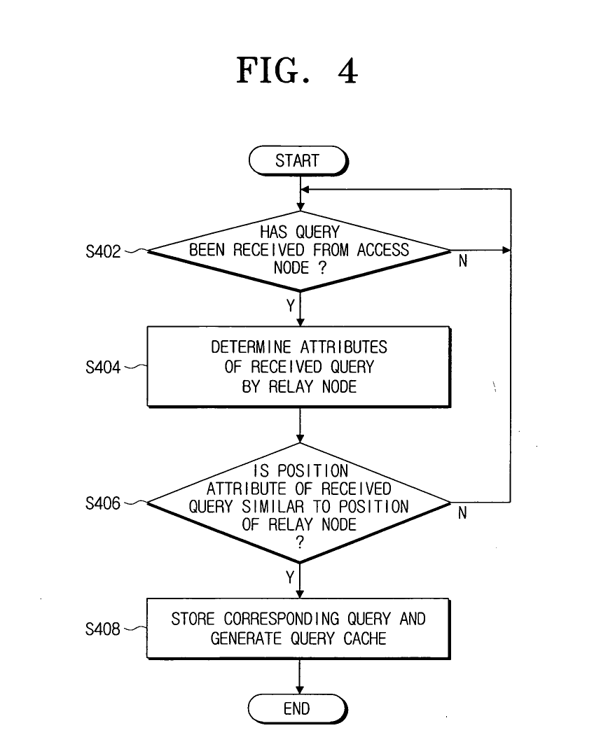

FIG. 4 is a flowchart of a task maintenance method using a query cache in a wireless sensor network according to an exemplary embodiment of the present invention.

In this exemplary embodiment, a user generates and transmits a query with respect to temperature, moisture, or the like of a specific room Room 1 in a wireless sensor network through a computer terminal. The specific room Room 1 is set to an interest area, and sensor nodes 212 and 214 connected to a relay node 210 in the interest area, by a wired or wireless connection, sense the temperature, moisture, or the like to perform a response to the query.

The query transmitted from the computer terminal of the user is transmitted to an access node 110 through the Internet or the like, and the access node 110 broadcasts the corresponding query to all of relay nodes R in the wireless sensor network.

In operation S402, a determination is made as to whether the relay node 210 in the interest area has received the query broadcast by the access node 110.

If it is determined in operation S402 that the relay node 210 has received the query from the access node 110, the relay node 210 determines the attributes of the query including position information thereof in operation S404. Exemplary attributes of the query are shown in Table 1 below.

TABLE 1

| Attribute | Meaning |
|---|---|
| Location | Information as to Place Desired for Sensing |
| Sensing | Type of Desired Sensing (for example, Temperature, |
| Type | Moisture, Illumination, or the like) |
| Sampling | Transmitting Period after Sensing (for example, One |
| Rate | Time per 10 Second) |
| Start Time | Time Required for Transmitting First Response to Query |
| End Time | Time Required for Transmitting Last Response to Query |

In step S406, the relay node determines if the position attribute of the received query is similar to the position attribute of the relay node. If the relay node 210 determines in operation S406 that the position attribute of the query is similar to the position information thereof, the relay node 210 stores the query received from the access node 110 through broadcasting and generates a query cache in operation S408.

The relay node 210 transmits the query to the sensor nodes 212 and 214 connected thereto and corresponding to the position attribute of the query, based on the position attribute of the query.

If the relay node 210 determines in operation S406 that the position attribute of the query is not similar to the position information thereof, the relay node returns to a state of awaiting a query.

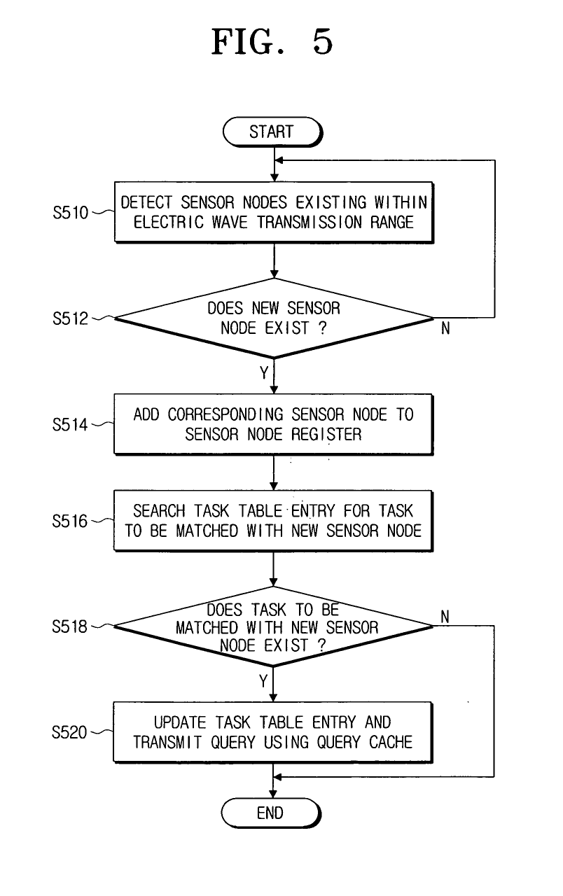

FIG. 5 is a flowchart of a task maintenance method using a query cache in a wireless sensor network when a new sensor node is installed according to an exemplary embodiment of the present invention.

In operation S510, a relay node 210 detects sensor nodes installed within an electric wave transmission range thereof in a wireless sensor network.

If the relay node detects in operation S512 that a second sensor node 310 is newly installed as shown in FIG. 3, the relay node 210 additionally registers the second sensor node 310 in a sensor node register in operation S514.

In operation S516, the relay node 210 searches a task table entry for a task to be matched with the second sensor node 310. For example, the relay node 210 checks whether a query having been transmitted to other sensor nodes exists.

In operation S518, the relay node 210 determines if a query having been transmitted from a user terminal to other sensor nodes exists and is a task to be matched with the second sensor node 310. If such a query exists, the relay node 210 adds information as to the second sensor node 310 in the task table entry to update the task table entry and then transmits the corresponding query to the second sensor node 310 using the query cache in operation S520. Thus, the second sensor node 310 receives the query having been transmitted to other sensor nodes to perform the corresponding task so as to maintain the task.

Additionally, information as to the newly installed sensor node 310 may be transmitted to the user.

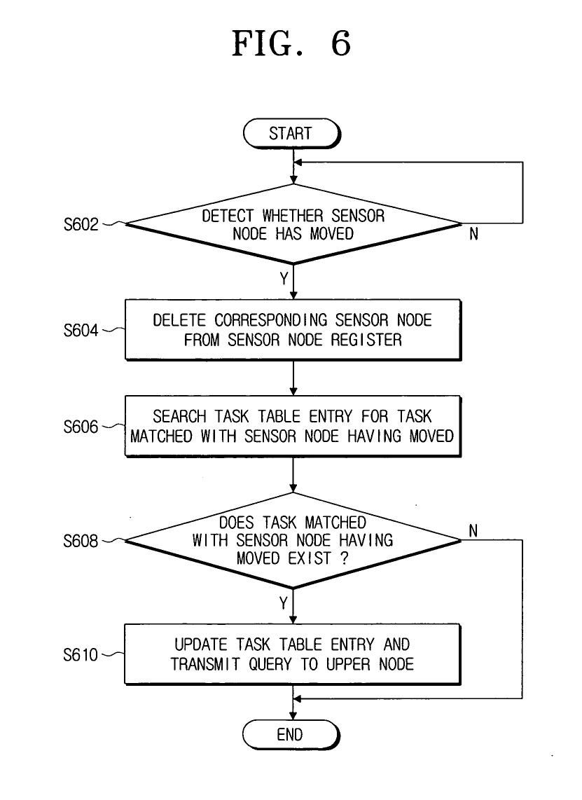

FIG. 6 is a flowchart of a task maintenance method using a query cache in a wireless sensor network when sensor nodes move.

In operation S602, a relay node 210 detects whether a sensor node, for example sensor node 310, has moved in a wireless sensor network. If the relay node 210 detects in operation S602 that an arbitrary sensor node within an electric wave transmission range of the relay node 210 moves into an electric wave transmission range of another relay node, the relay node 210 deletes the corresponding sensor node from a sensor node register in operation S604.

In operation S606, the relay node 210 searches a task table entry for a task matched with the second sensor node 310.

If the relay node 210 determines in operation S608 that a query is transmitted from an access node 110 to the second sensor node 310 and thus the task matched with the second sensor node 310 exists, the relay node 210 deletes information as to the second sensor node 310 from the task table entry to update the task table entry and then transmits the information to the access node 110 as an upper node in operation S610.

Accordingly, the information deleted from the task table entry is transmitted through the access node 110 to a computer terminal so that a user may take a subsequent action based on the deletion of the information. Also, a corresponding sensor node can be deleted from the task table entry so as to prevent energy waste caused by an unnecessary transmission of a query.

In a case where a sensor node S in an interest area moves to another area, the sensor node S receives a query from another relay node using a query cache to perform a sensing operation with respect to the query so as to maintain a task in its movement.

As described above, according to the exemplary embodiments of present invention, a new sensor node can maintain a task of a previously generated query using a query cache in a wireless sensor network. Also, although the new sensor node moves from another area to a specific area in the wireless sensor network, the new sensor node can maintain the task of the corresponding query using the query cache.

The foregoing embodiments and advantages are merely exemplary and are not to be construed as limiting the present invention. The present exemplary teachings can be readily applied to other types of apparatuses. Also, the description of the embodiments of the present invention is intended to be illustrative, and not to limit the scope of the claims, and many alternatives, modifications, and variations will be apparent to those skilled in the art without departing from the spirit and scope of the invention as defined by the appended claims and the full scope of equivalents thereof.

What is claimed is:

1. A task maintenance method, comprising:
receiving a query from a user;
storing the query;
generating a query cache; and
transmitting the cached query to a corresponding sensor node.

2. The task maintenance method of claim 1, further comprising determining if the query comprises an attribute similar to an attribute of the corresponding sensor prior to storing the query and generating the query cache.

3. The task maintenance method of claim 2, wherein the attribute of the query comprises at least one of position information, a desired sensing type, a time required for sensing and transmitting, a time required for transmitting a first response to the query, and a time required for transmitting a last response to the query.

4. The task maintenance method of claim 1, further comprising determining if the query comprises a position attribute similar to position information of the corresponding sensor node prior to transmitting the cached query to the corresponding sensor node.

5. The task maintenance method of claim 1, further comprising transmitting the cached query to a newly installed sensor node.

6. The task maintenance method of claim 5, further comprising:
determining if a new sensor node is installed; and
adding the newly installed sensor node to a task table entry and transmitting information as to the newly installed sensor node if a sensor node is newly installed.

7. The task maintenance method of claim 1, further comprising searching for sensor nodes that stopped operating or no longer exist.

8. The task maintenance method of claim 7, further comprising
deleting sensor nodes that do not operate or do not exist from a task table entry; and
transmitting information as to the deletion.

9. The task maintenance method of claim 1, further comprising transmitting the query to a sensor node that has moved from a first area to a second area.

10. The task maintenance method of claim 1, wherein receiving a query comprises receiving a query from an access node.

11. A sensor network, comprising:
an access node;
at least one relay node; and
at least one sensor node,
wherein the at least one relay node receives a query from the access node, stores the query to generate query cache and transmits the cached query to a corresponding sensor node.

12. The sensor network of claim 11, comprising determining, by the at least one relay node, if the query comprises an attribute similar to an attribute of the corresponding sensor node prior to storing the query and generating the query cache.

13. The sensor network of claim 12, wherein the attribute of the query comprises at least one of position information, a desired sensing type, a time required for sensing and transmitting, a time required for transmitting a first response to the query, and a time required for transmitting a last response to the query.

14. The sensor network of claim 11, wherein the at least one relay node transmits the cached query to the corresponding sensor node, if the corresponding sensor node has position information similar to a position attribute of the query.

15. The sensor network of claim 11, wherein the at least one relay node transmits the cached query to a newly installed sensor node in the sensor network.

16. The sensor network of claim 15, wherein the at least one relay node determines if a new sensor node is installed, adds the newly installed sensor node to a task table entry and transmits information as to the newly installed sensor node to the user if a sensor node is newly installed.

17. The sensor network of claim 11, wherein the at least one relay node searches for sensor nodes that stopped operating or no longer exist.

18. The sensor network of claim 17, wherein the at least one relay node deletes sensor nodes that do not operate or do not exist from a task table entry and transmits information as to the deletion to the access node.
